(19) United States
(12) Patent Application Publication
(10) Pub. No.: US 2016/0098380 A1
(43) Pub. Date: Apr. 7, 2016

(54) MAPPING OF CONTENT ON A WEB SITE TO PRODUCT FUNCTIONALITY

(71) Applicant: CONDUCTOR, INC., NEW YORK, NY (US)

(72) Inventors: MICHAEL RUBINO, SUNNYSIDE, NY (US); VISHAL R. BERRY, NEW YORK, NY (US); MARINA YOSPE, BROOKLYN, NY (US); JOSHUA D. ROSENBLUM, BROOKLYN, NY (US); SETH DOTTERER, CORTLANDT MANOR, NY (US)

(21) Appl. No.: 14/877,505

(22) Filed: Oct. 7, 2015

Related U.S. Application Data
(60) Provisional application No. 62/061,117, filed on Oct. 7, 2014.

(51) Int. Cl. G06F 17/21; H04L 29/08

(52) U.S. Cl. CPC G06F 17/212; H04L 67/02

(57) ABSTRACT

A method for generating a content map. The method may include, by a content processor, receiving a selection of a first URL for a first content segment. The method may include receiving a selection of a second URL for a second content segment. The method may include grouping the first and second content segment into a first dimension group. The method may include receiving a selection of a third URL for a third content segment. The method may include receiving a selection a fourth URL for a fourth content segment. The method may include grouping the third and fourth content segment into a second dimension group. The method may include relating the first and second URL in the first dimension group and the third and fourth URL in the second dimension group to generate a content map. The method may include causing the content map to be displayed.

### CROSS REFERENCE TO RELATED APPLICATIONS

This application claims priority to U.S. Provisional Application No. 62/061,117 filed Oct. 7, 2014, the entirety of which is hereby incorporated by reference.

### BACKGROUND

In a search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Users may modify web pages in an attempt to have their page appear higher in a result set for particular queries.

### SUMMARY

In some examples, methods for generating a content map are described. The methods may include a content processor receiving a selection of a first URL in a set of URLs for a first content segment. The methods may include the content processor receiving a selection of a second URL in the set of URLs for a second content segment. The methods may include the content processor grouping the first content segment and second content segment into a first dimension group. The methods may include the content processor receiving a selection of a third URL in the set of URLs for a third content segment. The methods may include the content processor receiving a selection a fourth URL in the set of URLs for a fourth content segment. The methods may include the content processor grouping the third content segment and fourth content segment into a second dimension group. The methods may include the content processor relating the first URL and the second URL in the first dimension group and the third URL and the fourth URL in the second dimension group to generate a content map. The methods may include the content processor causing the content map to be displayed on a display.

In some examples, systems to generate a content map are described. The systems may include a memory. The memory may include instructions. The systems may include a content processor. The content processor may be in communication with the memory. The content processor may be effective to receive a first URL in a set of URLs for a first content segment. The content processor may be effective to store the first URL and the first content segment in the memory. The content processor may be effective to receive a second URL in the set of URLs for a second content segment. The content processor may be effective to store the second URL and the second content segment in the memory. The content processor may be effective to retrieve the first content segment and the second content segment from the memory. The content processor may be effective to group the first and second content segment into a first dimension group. The content processor may be effective to store the first dimension in the memory. The content processor may be effective to receive a third URL in the set of URLs for a third content segment. The content processor may be effective to store the third URL and the third content segment in the memory. The content processor may be effective to receive a fourth URL in the set of URLs for a fourth content segment. The content processor may be effective to store the fourth URL and the fourth content segment in the memory. The content processor may be effective to retrieve the third content segment and the fourth content segment from the memory. The content processor may be effective to group the third and fourth content segment into a second dimension group. The content processor may be effective to store the second dimension group in the memory. The content processor may be effective to relate the first URL and the second URL in the first dimension group and the third URL and the fourth URL in the second dimension group to generate a content map. The content processor may be effective to display the content map on a display.

In some examples, processor generated user interfaces to display a content map on a display are described. The interfaces may comprise a first content segment including a first URL. The interfaces may comprise a second content segment including a second URL. The interfaces may comprise a third content segment including a third URL. The interfaces may comprise a fourth content segment including a fourth URL. The interfaces may comprise a first dimension group displayed on the display. The first dimension group may include the first content segment and the second content segment. The interfaces may comprise a second dimension group displayed on the display. The second dimension group may include the third content segment and the fourth content segment. The interfaces may comprise an intersection between the first dimension group and the second dimension group.

In some examples, systems to generate a content map are described. The systems may include a memory. The systems may include a display. The systems may include a processor. The processor may be in communication with the memory and the display. The processor may be effective to receive a set of URLs. The processor may be effective to send the set of URLs to a content processor. The processor may be effective to receive a content map from the content processor. The content map may include a first dimension group and a second dimension group. The first dimension group may include a first content segment and a second content segment. The first content segment may include a first URL in the set of URLs. The second content segment may include a second URL in the set of URLs. The second dimension group may include a third content segment and a fourth content segment, The third content segment may include a third URL in the set of URLs. The fourth content segment may include a fourth URL in the set of URLs. The processor may be effective to send the content map to be displayed on the display.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system in accordance with an embodiment of the invention.

FIG. 2a illustrates a custom content segment screen of a user interface in accordance with an embodiment of the invention.

FIG. 2b illustrates a custom content segment screen of user interface 119 in accordance with an embodiment of the invention.

FIG. 3 illustrates a content map user interface in accordance with an embodiment of the invention.

FIG. 4 is a screen shot illustrating a content map of a system in accordance with an embodiment of the invention.

FIG. 5 is a screen shot illustrating a content map of a system in accordance with an embodiment of the invention.

FIG. 6 is a screen shot of a content map of a system in accordance with an embodiment of the invention.

FIG. 7 is a flow diagram illustrating a method which may be performed in accordance with an embodiment of the invention.

### DETAILED DESCRIPTION OF THE PREFERRED EMBODIMENT(S)

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

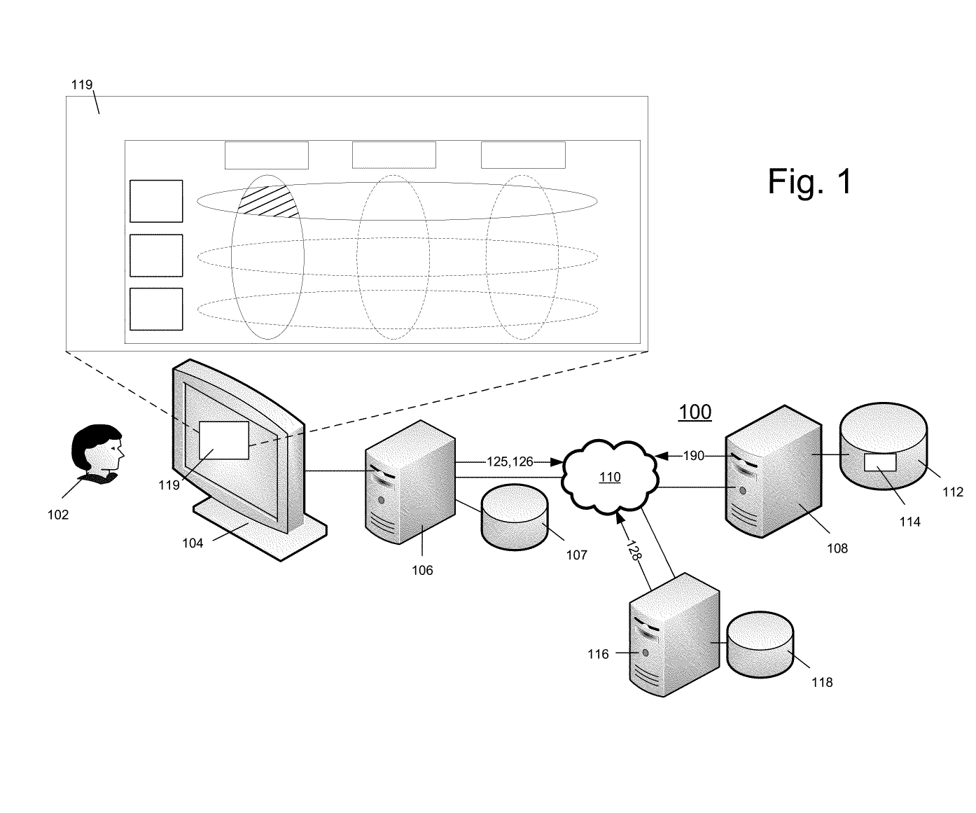

FIG. 1 is a system drawing of a system in accordance with an embodiment of the invention. System 100 may include a processor 106, a processor 108, and a processor 116. Processor 106, processor 108, and processor 116 may all be configured to be in communication through a network 110. Network 110 could include, for example, the Internet or a Local Area Network (“LAN”). Processor 106 may be in communication with a display 104 and a memory 107. Display 104 may be configured to display a user interface 119 which may include reports. Processor 108 may be in communication with a memory 112. Memory 112 may include instructions 114. Processor 116 may be in communication with a memory 118. Processor 116 may be associated with a search engine such as GOOGLE, YAHOO, BING, etc.

A user 102 may want to increase web presence or sales of product(s) or brand(s) of user 102. User 102 may utilize user interface 119 displayed on display 104 to send a request from processor 106 over network 110 to processor 108 for reports. Processor 108 may generate user interface 119 to be displayed on display 104 as described in more detail below.

Processor 108 may receive data 126 related to content located on a site of user 102 from processor 106 over network 110. Data 126 may include domains or URLs owned or operated by user 102. Processor 108 may also receive keywords 125 from processor 106 over network 110 related to requests of user 102. Keywords 125 may comprise one or more characters, symbols, phrases and/or words. Processor 108 may send keywords 125 and data 126 to processor 116 over network 110 and, in return, receive data 128 from processor 116 over network 110. Processor 108 may generate search engine optimization type reports 190 based on data 128. Data 128 received by processor 108 from processor 116 may include a set of URLs based upon analytics of received keywords 125 and URLs in data 126.

Instructions 114 may include instructions effective to generate user interface 119. User interface 119 may display data 128 as a content map on display 104 effective to show a relationship among: dimension groups (shown illustratively as rectangles) of content segments, URLs for each of the dimension groups (shown as ellipses) and intersection data between URLs for each dimension group. As explained in more detail below, user interface 119 on display 104 may enable user 102 to view content and analytics of data 128 received from processor 116. Data 128 may include URLs such as URLs being tracked by user 102, URLs in search results produced by a search engine based on keywords 125, and URLs sourced from user 102 website analytics data. Data 128 may include URLs from a content site's sitemap directly uploaded by user 102. Data 128 may include URLs uploaded by an application program interface (API) integration such as a content management system (CMS) like WORDPRESS or ADOBE EXPERIENCE MANAGER. Data 128 may include URLs and URLs associated with websites owned by a competitor of user 102. User interface 119 may enable user 102 to select URLs of interest from content displayed on user interface 119 to generate content groups or content segments.

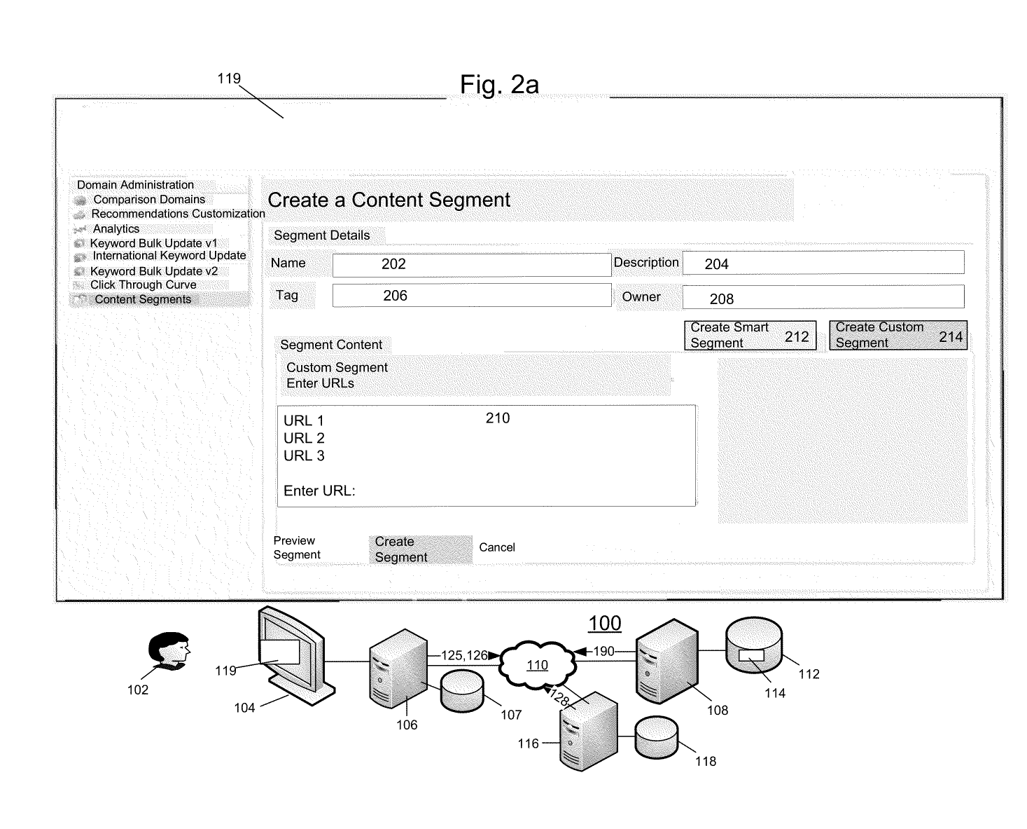

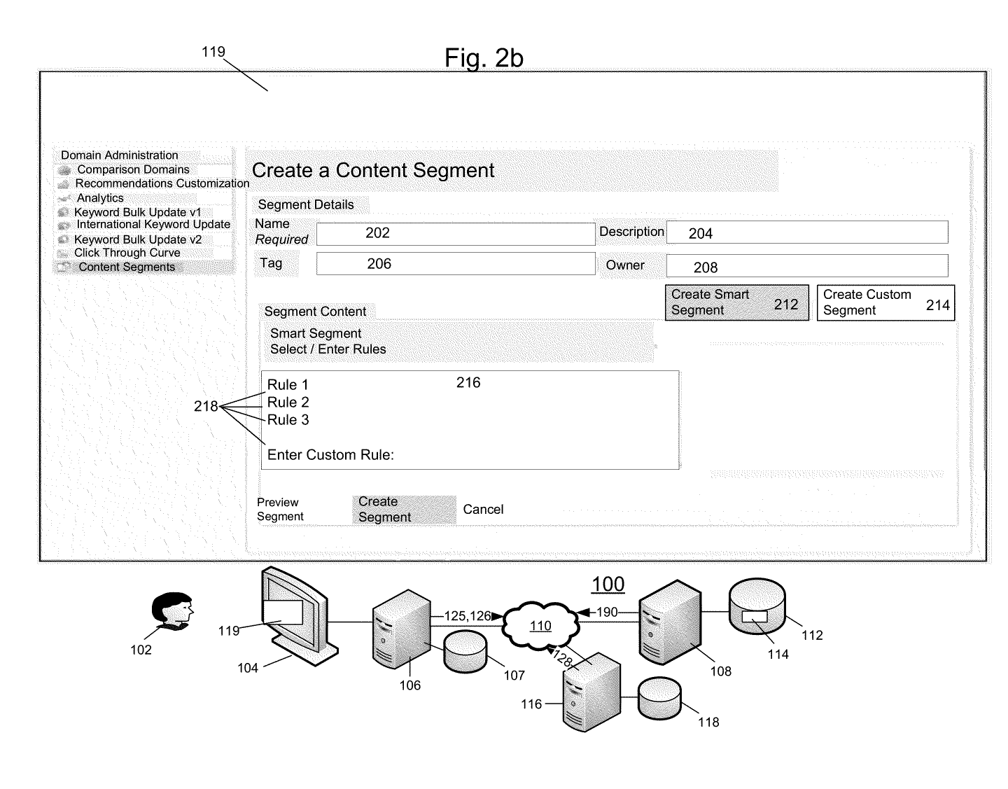

FIG. 2a illustrates a custom content segment screen of user interface 119 in accordance with an embodiment of the invention. Those components in FIG. 2a that are labeled identically to components of FIG. 1 will not be described again for the purposes of clarity.

User interface 119 may include fields for creating a content segment. User interface 119 may include fields for a use to input a name 202, a description 204, a tag 206, and an owner 208 for a content segment. User interface 119 may include fields to enable a user to create a smart segment 212 or to create a custom segment 214. User 102 may input a name, a description, a tag, and an owner in respective fields 202, 204, 206, and 208. User 102 may select create custom segment 214 from user interface 119. Selection of create custom segment 214 may result in processor 108 executing instructions 114 and user interface 119 presenting a field 210 for user 102 to input and/or select URLs for a custom content segment. User 102 may input and/or select URLs for a custom content segment in field 210. URLs in field 210 may include URLs in data 128. For example, user 102 may select a URL related to a page with pants and a URL related to a page with shirts in field 210 of user interface 119. User 102 may input “clothes” in field 202 to request processor 108 to generate a content segment named “clothes” that includes the URL related to pants and the URL related to shirts. Processor 108 may generate content segments based on inputs and selections received from user 102 through user interface 119.

FIG. 2b illustrates a custom content segment screen of user interface 119 in accordance with an embodiment of the invention. Those components in FIG. 2b that are labeled identically to components of FIGS. 1 and 2a will not be described again for the purposes of clarity.

User interface 119 may additionally enable user 102 to determine rules for selecting URLs for a content segment. User 102 may select create smart segment 212 from user interface 119. Selection of create smart segment 212 may result in user interface 119 presenting a rule field 216. Rule field 216 may include rules 218 for user 102 to select relating to criteria for determining URLs for a smart content segment. Rule field 216 may also allow user 102 to input a custom rule 218 relating to criteria for determining URLs from data 128 for a smart content segment. Selected or input rule 218 may define criteria for processor 108 to select URLs from data 128 and create a smart content segment. Rule 218 may be based on content of a URL, for example, rule 218 may determine URLs to select for a content segment based on the title or description in hypertext markup language (HTML) crawled from a URL. Rule 218 may be based on analytic data associated with a URL, for example, rule 218 may determine URLs to select for a content segment based on a number of visitors to the URL in a determined timeframe. Rule 218 may be based on visibility measures such as rank in a natural search of a search engine. For example, rule 218 may determine URLs to select for a content segment based on URLs with a rank 5 or higher for a particular keyword or collection of keywords. A smart content segment may be created by processor 108 from one rule 218 or from multiple rules 218. User 102 may create a smart content segment by processor 108 by selecting multiple rules 218 from field 216. User 102 may designate a method for processor 108 to combine multiple rules 218. For example user 102 may designate to combine first rule 218 and second rule 218 so that URLs selected for a smart segment by processor 108 comply with both first rule 218 and second rule 218. In another example, user 102 may designate to combine first rule 218 or second rule 218 so that URLs selected for a smart segment by processor 108 comply with either first rule 218 or second rule 218. For example, user 102 may select a first rule 218 “URLs ending in .edu” from field 216 and a second rule 218 “URLs associated with HARVARD” from field 216 to create a smart content segment with two rules. Processor 108 may then select URLs ending in .edu and associated with HARVARD from data 128 to create a smart content segment.

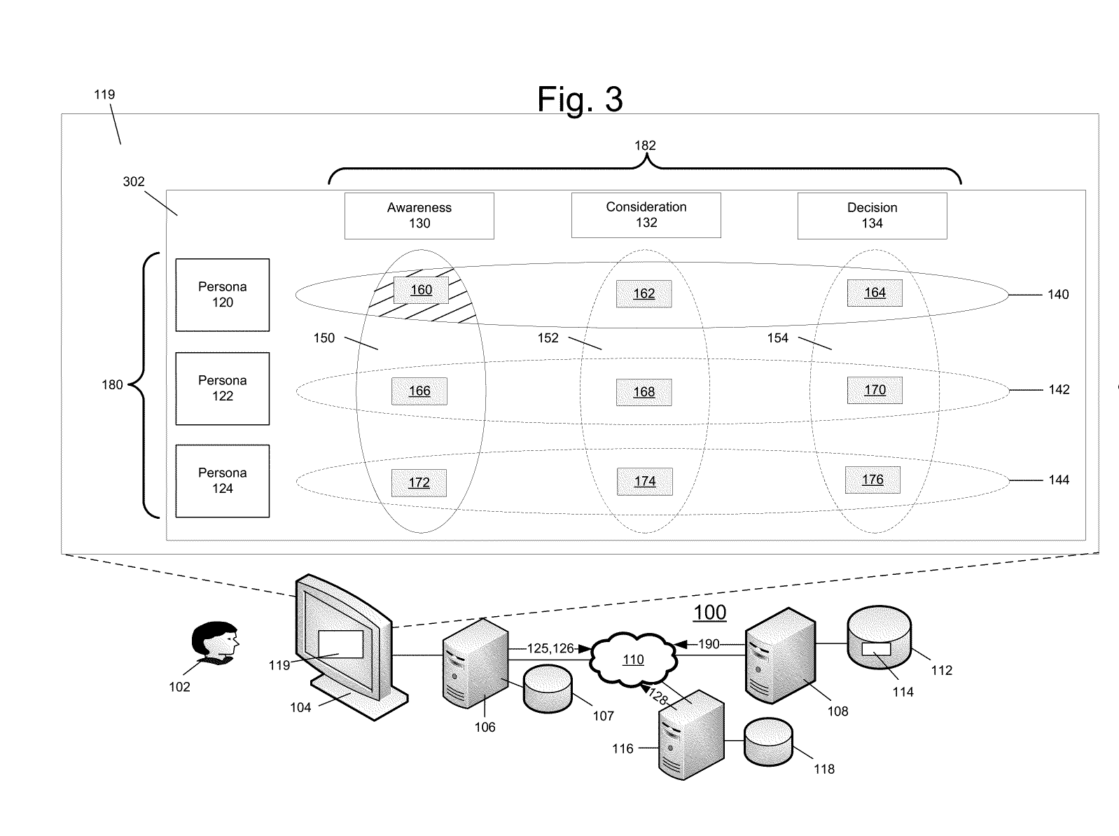

FIG. 3 illustrates a content map user interface 119 in accordance with an embodiment of the invention. Those components in FIG. 3 that are labeled identically to components of FIG. 1-2b will not be described again for the purposes of clarity.

User 102 may define a dimension group through user interface 119. A dimension group may be an aggregation or grouping of content segments as defined by user 102. User 102 may define dimension groups 120, 122, 124, 130, 132,134 through user interface 119. User interface 119 may display search engine results data 128 included in content segments determined for each of dimension groups 120, 122, 124, 130, 132, 134 as sets of URLs 140, 142, 144, 150, 152, and 154 respectively on display 104. Each set of URLs 140, 142, 144, 150, 152, and 154 may include URLs included in content segments and search engine results data 128 associated with each respective dimension group 120, 122, 124, 130, 132, and 134. For example, a content segment “markers” may be included in a dimension group related to school supplies. In another example, a dimension group “chef” may include content segments “cooking” and “entertaining”. The content segment “cooking” may in turn include URLs that relate to cooking hamburgers, steak, etc.

In an example, a group of dimension groups may be identified as a category 180. For example the category 180 may be “customer” and may include dimension groups 120, 122, 124, each dimension group corresponding to a persona of a different customer. Dimension groups 120, 122, and 124 may include content segments and URLs associated with a specific target customer. Category 180 may be defined by user 102.

As shown in content map 302, dimension group 120 may include the set of URLs 140. Similarly, persona 122 may include the set of URLs 142 and persona 124 may include the set of URLs 144. For example, persona 120 may be associated with customers classified as foodies, persona 122 may be associated with customers classified as techies, and persona 124 may be associated with customers classified as students.

In another example of a grouping of dimension groups, user 102, through user interface 119, may generate a category 182 of dimension groups based on a journey a customer may take when purchasing an item or a buyer's journey. Category 182 may include dimension group awareness stage 130 for a buyer defined as early stage, or awareness stage. For example, a buyer just gathering information about a product such as looking at blogs or at a product information comparison page, may be defined as early or awareness stage by user 102. User 102 may create a dimension group and select content segments for dimension group awareness stage 130. User 102 may select content segments with URLs associated with blogs and product information pages from data 128 through user interface 119 for dimension group awareness stage 130. User 102 may generate dimension group consideration stage 132, for a buyer defined by user 102 as middle stage, or consideration stage. For example, content such as a “technical guide” or a URL ending in “technical guide” may be defined as middle or consideration stage by user 102. User 102 may select content segments with URLs ending in “technical guide” from data 128 for dimension group consideration stage 132. User 102 may generate dimension group decision stage 134, for a buyer defined as final stage, or decision stage. For example, a buyer that is making a decision as to which product to buy, such as by looking at product pricing pages or categories and not just looking at product information content pages, may be defined as final or decision stage by user 102. User 102 may select content segments with URLs associated with product pricing pages from data 128 for dimension group decision stage 134. As shown in content map 302, dimension group awareness stage 130 may include a set of URLs 150 associated with content segments selected for dimension group awareness stage 103. Similarly, dimension group consideration stage 132 may include a set of URLs 152 associated with content segments selected for dimension group consideration stage 132 and dimension group decision stage 134 may include a set of URLs 154 associated with content segments selected for dimension group decision stage 134.

Processor 108 may generate and display content map 302 on display 104. Content map 302 may relate two or more dimension groups as created by user 102. Processor 108 may generate content map 302 by associating a first dimension group or group of dimension groups with a first axis of the content map and associating a second dimension group or group of dimension groups with a second axis of the content map. For example, category 180 may be displayed along a first axis of content map 302 and category 182 may be displayed along a second axis of content map 302. Dimension groups 120, 122, and 124 included in category 180 may be displayed along the first axis of content map 302 and dimension groups 130, 132, and 134 included in category 182 may be displayed along the second axis of content map 302. Sets of URLs 140, 142, and 144 associated with dimension groups 120, 122, and 124 respectively may be displayed along the first axis of content map 302. Sets of URLs 150, 152, and 154 associated with dimension groups 130, 132, and 134 respectively may be displayed along the second axis of content map 302. Processor 108 may identify intersection data groups between sets of URLs 140, 142, 144 and sets of URLs 150, 152, 154. For example, processor 108 may determine intersection data group 160 common to both set of URLs 140 associated with dimension group 120 and set of URLs 150 associated with dimension group awareness stage 130. Intersection data group 160 may include one or more URLs associated with dimension group 120 and dimension group awareness stage 130. Processor 108 may determine intersection data groups for each intersection between dimension groups 120, 122, and 124 and dimension groups 130, 132, and 134.

Processor 108, executing instructions 114, may obtain analytics with respect to data associated with content map 302. Analytics may be obtained for dimension groups 120, 122, 124, 130, 132, 134, and/or for intersection data groups 160, 162, 164, 166, 168, 170, 172, 174, 176. Analytics may include facts for each URL in a dimension group or intersection data group, reports for each dimension group or intersection data group such as performance of the dimension group or intersection data group with regard to SEO (search engine optimization) visibility, revenues bounce rates, etc. Processor 108 may display data associated with dimension groups 120, 122, 124, 130, 132, 134, and/or intersection data groups 160, 162, 164, 166, 168, 170, 172, 174, 176. Processor 108 may display data related to aggregate information for the content of each dimension group or intersection group, including average title length, hypertext transfer protocol (HTTP) response codes, metrics based on the actual content of the page, and visibility (number of visits) of page content in one or more channels.

Processor 108 may send report data 190 to processor 106 to be displayed on display 104 and user interface 119. User 102 may utilize user interface 119 to evaluate data and analytics associated with report data 190. User 102 may be able to utilize user interface 119 to select particular data and obtain additional information such as analytics and URLs. For example, processor 108 may identify changes in intersection data groups over periods of time. Dimension groups in the content map may be pivoted and aligned to different axis. A user can sort dimension groups by analytics such as revenue, bounce rate, time on a site, etc. URLs that correspond to defined dimension groups may change over time in response to application of rules to new or changing web pages.

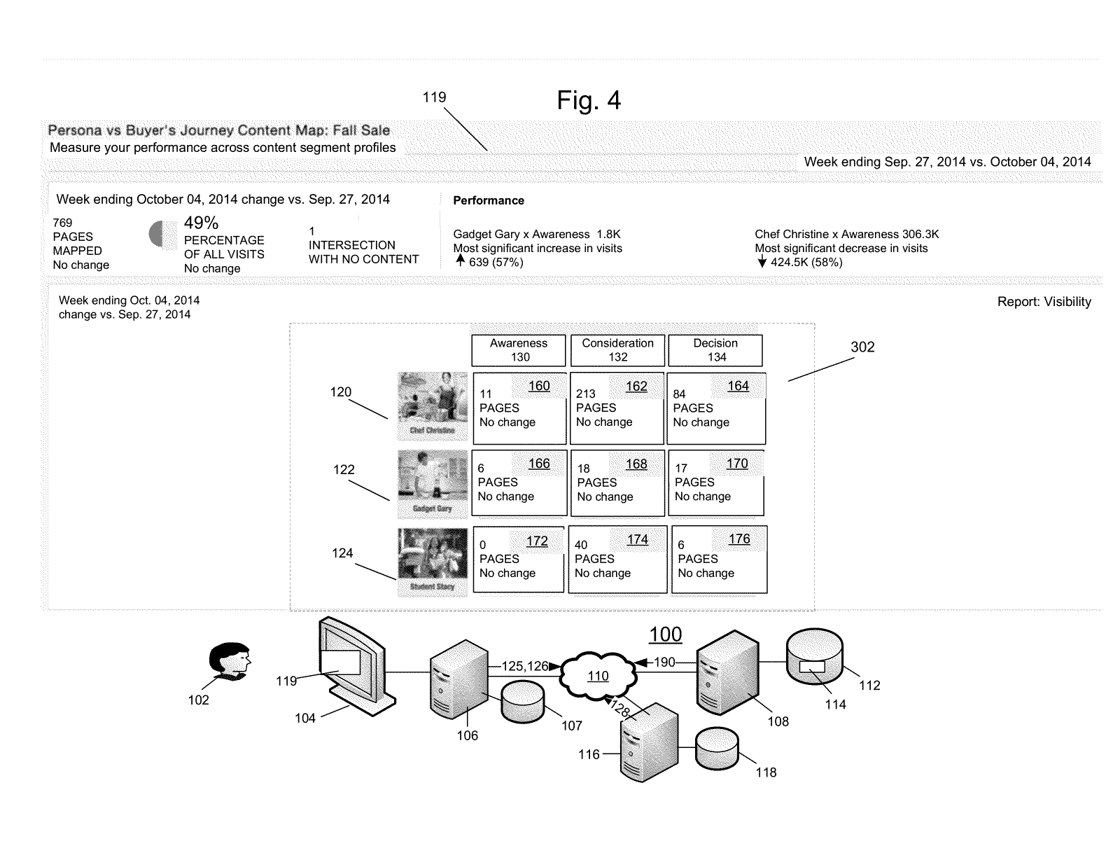

FIG. 4 is a screen shot illustrating a content map of a system in accordance with an embodiment of the invention. Those components in FIG. 4 that are labeled identically to components of FIG. 1-3 will not be described again for the purposes of clarity.

FIG. 4 illustrates content map 302 with data indicating web pages associated with each intersection data group 160, 162, 164, 166, 168, 170, 172, 174, and 176. For example, intersection data group 160 indicates 11 web pages associated with both dimension group 120 and dimension group 130. Intersection data group 172 indicates that there are no web pages associated with dimension group 124 and dimension group 130.

Processor 108 may also compare current data for number of webpages associated with each intersection data group with historic data saved in memory 112. Processor 108 may display changes in present number of webpages associated with each intersection data group from historical data for each intersection data group. User 102 may utilize information about a number of web pages associated with each intersection data group and changes from historical data to optimize SEO.

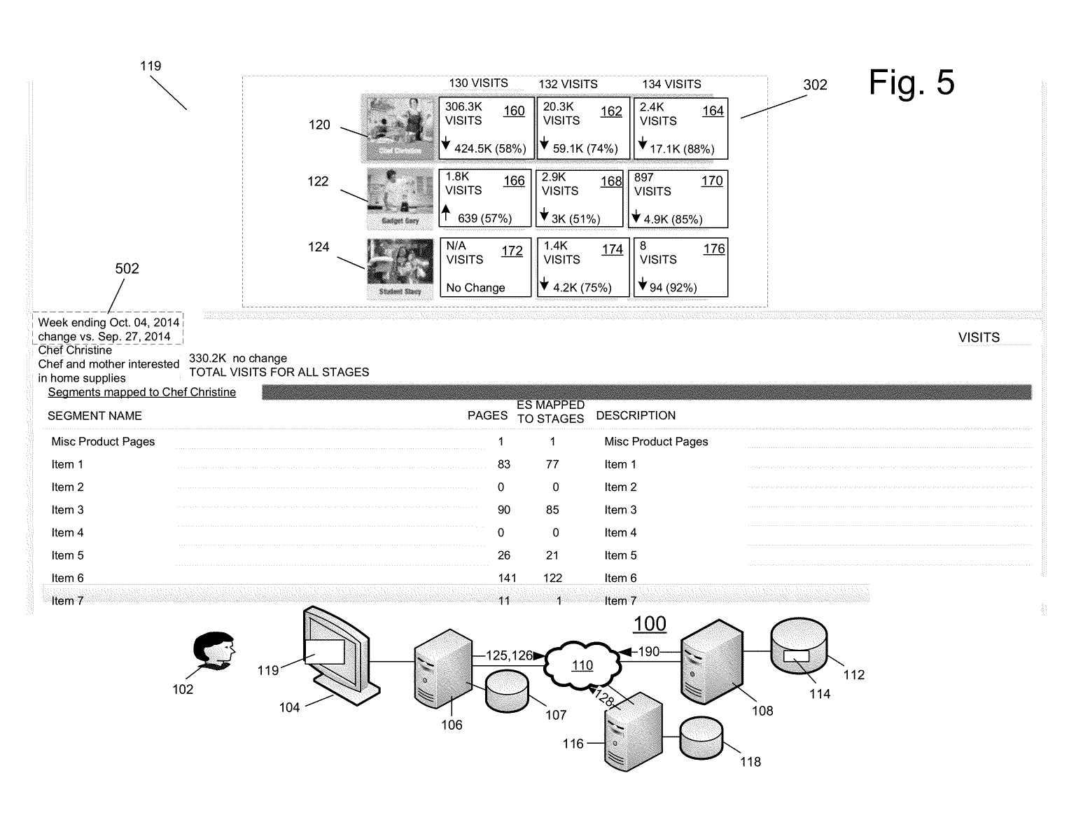

FIG. 5 is a screen shot illustrating a content map of a system in accordance with an embodiment of the invention. Those components in FIG. 5 that are labeled identically to components of FIG. 1-4 will not be described again for the purposes of clarity.

FIG. 5 illustrates content map 302 with intersection data groups 160, 162, 164, 166, 168, 170, 172, 174, and 176 indicating a number of visits to pages associated with each intersection data group 160, 162, 164, 166, 168, 170, 172, 174, and 176. For example, intersection data group 160 indicates that web pages associated with both dimension group 120 and 130 were visited 306,300 times in a time period shown at 502 of Sep. 27, 2014 through Oct. 4, 2014.

Processor 108 may also compare current data for number of visits associated with each intersection data group with historic data saved in memory 112. Processor 108 may display changes in present number of visits associated with each intersection data group from historical data for each intersection data group as a percentage increase or decrease. User 102 may utilize information about number of visits associated with each intersection data group and changes from historical data to optimize SEO.

User 102 may select analytics related to a dimension group. As shown in FIG. 5, user interface 119 may include additional information related to the selection of a particular dimension group. For example, in FIG. 5, user 102 has selected information associated with dimension group 120 “Chef Christine”. Dimension group 120 “Chef Christine” may be associated with a customer persona user 102 is interested in targeting. In the example, dimension group 120 “Chef Christine” may be a customer who is a professional chef. User 102 may want to increase views or clicks on by professional chefs on user 102 website. Content segments and web pages associated with dimension group 120 “Chef Christine” are listed on user interface 119 and displayed on display 104 when dimension group 120 is selected by user 102. User 102 may utilize content segment and web page information associated with dimension group 120 to target an advertising campaign towards professional chefs.

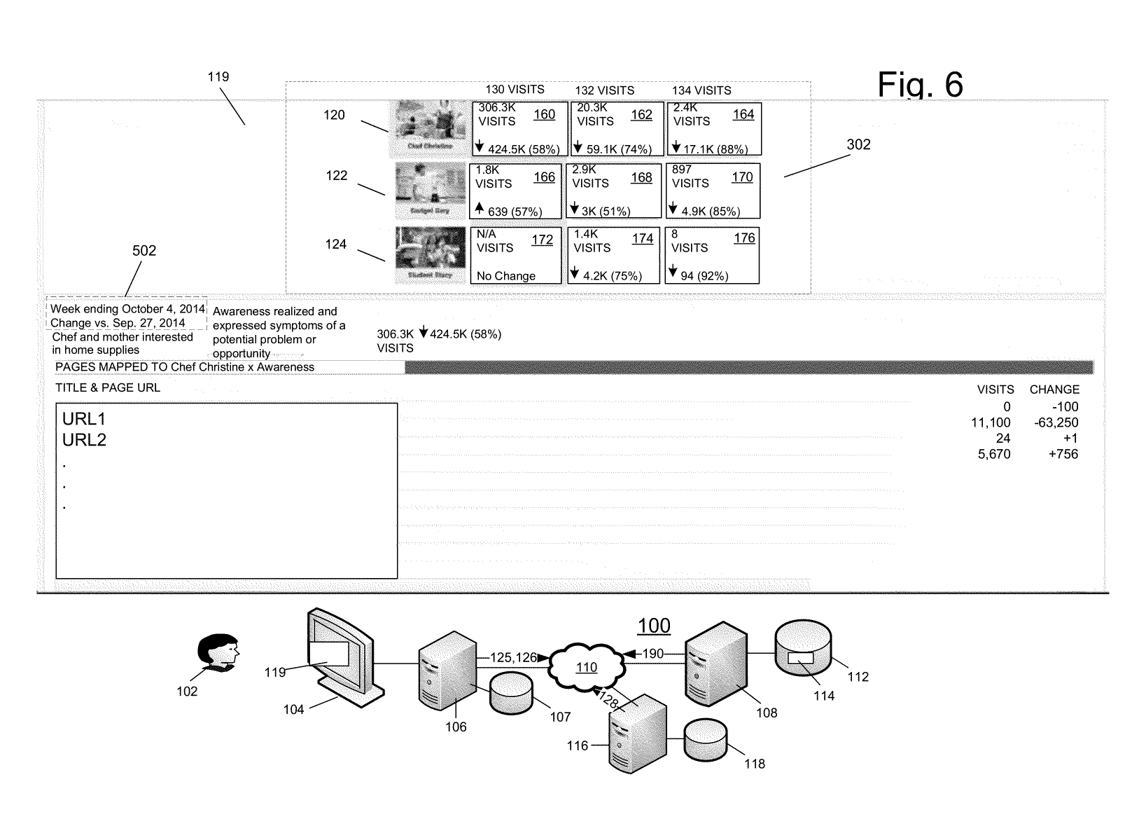

FIG. 6 is a screen shot illustrating a content map of a system in accordance with an embodiment of the invention. Those components in FIG. 6 that are labeled identically to components of FIG. 1-5 will not be described again for the purposes of clarity.

FIG. 6 illustrates content map 302 with intersection data groups 160, 162, 164, 166, 168, 170, 172, 174, and 176 indicating a number of visits to pages associated with each intersection data group 160, 162, 164, 166, 168, 170, 172, 174, and 176. User 102 may select analytics related to an intersection data group 160, 162, 164, 166, 168, 170, 172, 174, or 176. For example, in FIG. 6, information associated with intersection data group 160, the intersection or dimension group 120 and dimension group 130, is displayed by user interface 119 on display 104. Content segments and web pages associated with intersection data group 160 may be listed on user interface 119 and displayed on display 104 when intersection data group 160 is selected by user 102.

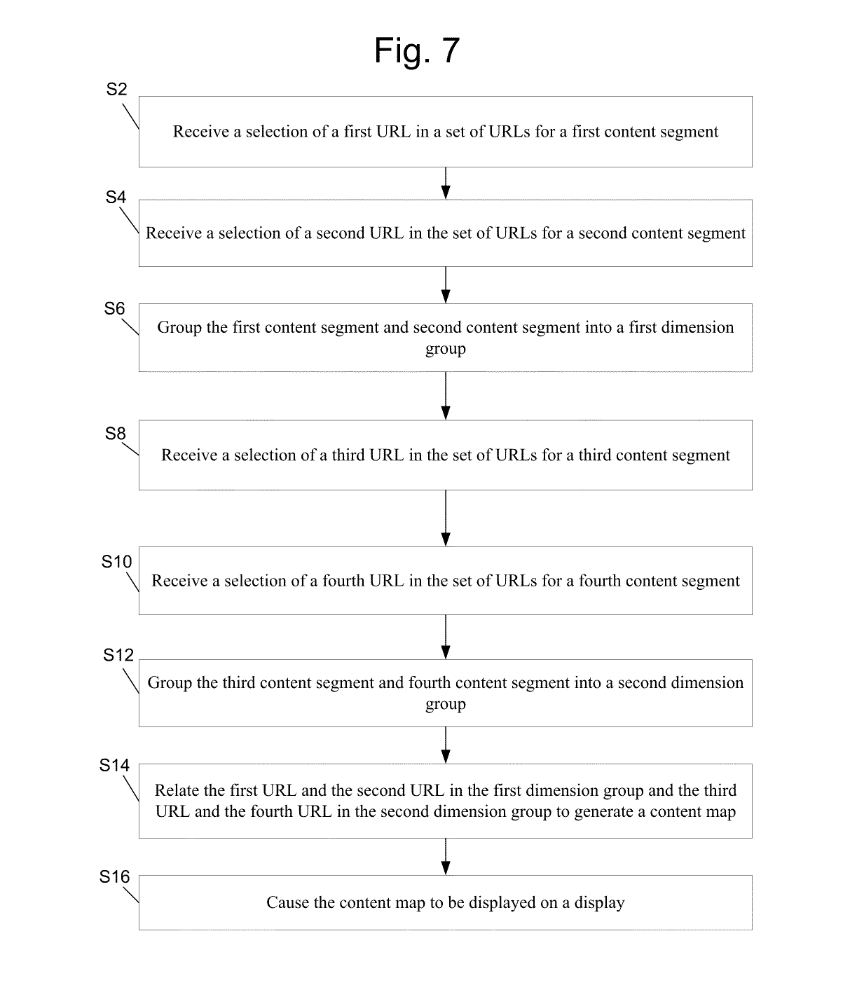

FIG. 7 is a flow diagram illustrating a method which may be performed in accordance with at least some embodiments presented herein. The method in FIG. 7 could be implemented using, for example, system 100 discussed above. The example method may include one or more operations, actions, or functions as illustrated by one or more of blocks S2, S4, S6, S8, S10, S12, S14 and/or S16. Although illustrated as discrete blocks, various blocks may be divided into additional blocks, combined into fewer blocks, or eliminated, depending on the desired implementation.

Processing may begin at block S2 “Receive a selection of a first URL in a set of URLs for a first content segment.” At block S2, a processor may receive a selection of a first URL. The first URL may be for a first content segment. The first content segment may include a first URL of interest to a user. The first content segment may include a first URL selected by a user for a custom first content segment. The first content segment may include rules for selection of a first URL for the first content segment. The processor may apply the rules to select a first URL for the first content segment.

Processing may continue from block S2 to block S4 “Receive a selection of a second URL in the set of URLs for a second content segment.” At block S4, the processor may receive a second URL. The second URL may be for a second content segment. The second content segment may include a second URL of interest to a user. The second content segment may include a second URL selected by a user for a custom second content segment. The second content segment may include rules for selection of a second URL for the second content segment. The processor may apply the rules to select a second URL for the second content segment.

Processing may continue from block S4 to block S6 “Group the first content segment and second content segment into a first dimension group.” At block S6, the processor may group the first content segment and the second content segment into a first dimension group. The first dimension group may group first content segment and second content segment as determine by a user through a user interface.

Processing may continue from block S6 to block S8 “Receive a selection of a third URL in the set of URLs for a third content segment.” At block S8, the processor may receive a third URL. The third URL may be for a third content segment. The third content segment may include a third URL of interest to a user. The third content segment may include a third URL selected by a user for a custom third content segment. The third content segment may include rules for selection of a third URL for the third content segment. The processor may apply the rules to select a third URL for the third content segment.

Processing may continue from block S8 to block S10 “Receive a selection of a fourth URL in the set of URLs for a fourth content segment.” At block S10, the processor may receive a fourth URL. The fourth URL may be for a fourth content segment. The fourth content segment may include a fourth URL of interest to a user. The fourth content segment may include a fourth URL selected by a user for a custom fourth content segment. The fourth content segment may include rules for selection of a fourth URL for the fourth content segment. The processor may apply the rules to select a fourth URL for the fourth content segment.

Processing may continue from block S10 to block S12 “Group the third content segment and fourth content segment into a second dimension group.” At block S12, the processor may group the third content segment and the fourth content segment into a second dimension group. The second dimension group may group third content segment and fourth content segment as determine by a user through a user interface.

Processing may continue from block S12 to block S14 “Relate the first URL and the second URL in the first dimension group and the third URL and the fourth URL in the second dimension group to generate a content map.” At block S14, the processor may relate the first URL and the second URL in the first dimension group with the third URL and the Fourth URL in the second dimension group to generate a content map. For example, the first dimension group may be associated with a first axis of the content map and the second dimension group may be associated with a second axis of the content map. The first and the second URL may be associated with the first axis of the content map and the third and the fourth URL may be associated with the second axis of the content map.

Processing may continue from block S14 to block S16 “Cause the content map to be displayed on a display.” At block S16, the processor may cause the content map to be displayed on the display. A user may view the content map displayed on the display.

Among other potential benefits, a system in accordance with the disclosure may provide a marketing professional with guidance as to where to focus search engine optimization efforts. A user may define content segments and dimension groups and utilize the system to display useful data related to the content set. Dimension groups may be defined and allow a user to identify complex search engine optimization data for customers and use of their web site. A user may be able to use displayed data to better coordinate campaigns to attract customers at earlier stages of a buyer journey. A user may determine that an increase in a certain value in a metric may yield a desired target number of visits in a desired customer profile. A user may identify an intersection that is underperforming or is unfilled, and may better determine where to allocate resources. A system in accordance with the present disclosure may identify discrepancies between a company's target customers and a company's web presence. Weekly data updates may provide a user with increasing and/or decreasing trends, and better provide an understanding of a product or marketing performance. A user may be able to determine a mismatch between early stage and late stage content and adjust strategy accordingly. A user may better align analytic targets to better reach target customers. A user may better understand the distribution of content across personas and a buyer's journey and may be able to identify content gaps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating a content map, the method comprising, by a content processor:
receiving a selection of a first URL in a set of URLs for a first content segment;
receiving a selection of a second URL in the set of URLs for a second content segment;
grouping the first content segment and second content segment into a first dimension group;
receiving a selection of a third URL in the set of URLs for a third content segment;
receiving a selection of a fourth URL in the set of URLs for a fourth content segment;
grouping the third content segment and fourth content segment into a second dimension group;
relating the first URL and the second URL in the first dimension group and the third URL and the fourth URL in the second dimension group to generate a content map; and
causing the content map to be displayed on a display.

2. The method of claim 1, further comprising causing an intersection between the first dimension group and the second dimension group in the content map to be displayed.

3. The method of claim 1, wherein the first URL is selected by a user through a user interface.

4. The method of claim 1, wherein the first content segment includes rules related to selecting the first URL, the method further comprising the processor selecting the first URL for the first content segment based on the rules.

5. The method of claim 1, wherein the grouping of the first and second content segment into a first dimension group includes a user grouping the first and second content segments through a user interface.

6. The method of claim 3, wherein the rules are first rules and the third content segment includes second rules related to selecting the third URL, the second rules being different from the first rules, the method further comprising the processor selecting the third URL for the third content segment based on the second rules.

7. The method of claim 1, wherein:
relating the first URL and the second URL in the first dimension group includes associating the first URL and the second URL in the first dimension group with a first axis of the content map; and
relating the third URL and the fourth URL in the second dimension group includes associating the third URL and the fourth URL in the second dimension group with a second axis of the content map.

8. The method of claim 2, wherein the determining of an intersection between the first dimension group and second dimension group includes the processor determining a URL in common to both the first dimension group and the second dimension group.

9. The method of claim 2, further comprising the processor obtaining analytics for the content map, wherein the analytics include information about the first dimension group, the second dimension group and/or the intersection.

10. A system to generate a content map, the system comprising:
a memory including instructions;
a content processor in communication with the memory, wherein the content processor is effective to:
receive a first URL in a set of URLs for a first content segment and store in the memory;
receive a second URL in the set of URLs for a second content segment and store in the memory;
retrieve the first content segment and the second content segment from the memory;
group the first and second content segment into a first dimension group and store the first dimension in the memory;
receive a third URL in the set of URLs for a third content segment and store in the memory;
receive a fourth URL in the set of URLs for a fourth content segment and store in the memory;
retrieve the third content segment and the fourth content segment from the memory;
group the third and fourth content segment into a second dimension group and store the second dimension group in the memory;
relate the first URL and the second URL in the first dimension group and the third URL and the fourth URL in the second dimension group to generate a content map; and
display the content map on a display.

11. The system op claim 10, wherein the content processor is effective to determine an intersection between the first dimension group and the second dimension group in the content map.

12. The system of claim 10, further comprising a user interface, wherein the first content segment is determined through the user interface.

13. The system of claim 10, wherein the first content segment includes rules related to the selection of the first URL and the processor is further effective to select the first URL for the first content segment based on the rules.

14. The system of claim 10, wherein a determination by a user through a user interface is used to group the first and second content segment into a first dimension group.

15. The system of claim 13, wherein the rules are first rules and the third content segment includes second rules related to the selection of the third URL, the second rules being different from the first rules, the processor further effective to select the third URL for the third content segment based on the second rules.

16. The system of claim 11, wherein the processor is effective to determine an intersection between the first dimension group and the second dimension group by a determination of a URL in common to both the first dimension group and the second dimension group.

17. The system of claim 11, wherein the processor is effective to obtain analytics for the content map, wherein the analytics include information about the first dimension group, the second dimension group and/or the intersection.

18. A processor generated user interface to display a content map on a display, the interface comprising:
a first content segment including a first URL;
a second content segment including a second URL;
a third content segment including a third URL;
a fourth content segment including a fourth URL;
a first dimension group displayed on the display, wherein the first dimension group includes the first content segment and the second content segment;
a second dimension group displayed on the display, wherein the second dimension group includes the third content segment and the fourth content segment; and
an intersection between the first dimension group and the second dimension group.

19. The processor generated user interface of claim 18, further comprising a field wherein the first URL is selected by a user through the user interface.

20. The processor generated user interface of claim 18, further comprising a field wherein a rule related to the selection of the first URL is selected by a user of the processor generated user interface, and the first URL is selected for the first content segment based on the rule.

21. A system to generate a content map, the system comprising:
a memory;
a display;
a processor in communication with the memory and the display, wherein the processor is effective to;
receive a set of URLs;
send the set of URLs to a content processor;
receive a content map from the content processor, wherein the content map includes a first dimension group and a second dimension group, the first dimension group including a first content segment and a second content segment, wherein the first content segment includes a first URL in the set of URLs and the second content segment includes a second URL in the set of URLs, the second dimension group including a third content segment and a fourth content segment, wherein the third content segment includes a third URL in the set of URLs and the fourth content segment includes a fourth URL in the set of URLs; and
send the content map to be displayed on the display.
